(19) United States
(12) Patent Application Publication
(10) Pub. No.: US 2006/0124624 A9
(43) Pub. Date: Jun. 15, 2006

(54) Flux cored wire for gas shield arc welding

(75) Inventors: Yong Chul Kim, Changwon (KR); Hwan Cheol Bang, Changwon (KR)

Correspondence Address: SQUIRE, SANDERS & DEMPSEY L.L.P, 600 HANSEN WAY, PALO ALTO, CA, 94304-1043, US

(73) Assignee: KISWEL LTD., Busan (KR)

(21) Appl. No.: 10/749,015

(22) Filed: Dec. 29, 2003

(30) Foreign Application Priority Data
Oct. 13, 2003 (KR) 10-2003-0070955

(51) Int. Cl. B23K 35/02

(52) U.S. Cl. 219/145.22

(57) ABSTRACT

Disclosed herein is a flux cored wire for gas shielded arc welding which comprises a seam section for improving the rectilinear property of the wire, thereby preventing the occurrence of bead meandering. The flux cored wire for gas shield arc welding is manufactured by forming a metal sheath, packing the inside of the metal sheath with a flux, followed by forming into a metal pipe shape and wire drawing and satisfies Relationship (1) below:
1.4≦(R_{rcts}/R_{ucts})≦4.0 (1)
wherein R_{rcts} represents the range of tensile strength of real cross section (real tensile strength range in a state where the flux is packed), and
R_{ucts} represents the range of tensile strength of unpacked cross section (real tensile strength range in a state where the flux is unpacked).

### BACKGROUND OF THE INVENTION

1. Field of the Invention

The present invention relates to a flux cored wire for gas shield arc welding used to weld mild steels, low-temperature steels, low alloy steels, high-tensile strength steels and the like. More particularly, the present invention relates to a flux cored wire for gas shield arc welding which has a seam section in the longitudinal direction for improving the rectilinear property of the wire, thereby preventing the occurrence of bead meandering.

2. Description of the Related Art

Many attempts for preventing the occurrence of bead meandering upon conventional welding wires have been made in various ways, for example, a method for lowering the tensile strength of a welding wire to a arbitrary value, a method for improving the rectilinear property of a welding wire by controlling the yield strength ratio of the welding wire, and a method for controlling a nominal wire diameter ratio, i.e. the ratio of the thickest diameter portion to the shortest diameter portion of the wire diameter which is measured in the circumferential direction.

An example of the method for lowering the tensile strength of a welding wire to a arbitrary value is disclosed in Japanese Patent No. 2542266. According to this patent, when the welding wire is annealed to lower its tensile strength, the elastic zone in a stress-strain curve plotted upon conducting the tension test of the welding wire is decreased and thus the plastic deformation of the welding wire is facilitated. While the low tensile strength welding wire is passed through a highly curved conduit cable for welding, it is deformed into a shape of the conduit cable. Thereafter, the linear welding wire is taken out in a linear form from the front end of a current contact tube to prevent the occurrence of bead meandering.

An example of the method for improving the rectilinear property of a welding wire by controlling the yield strength ratio of the welding wire is disclosed in Japanese Patent Laid-open No. 2002-301590, in which the rectilinear property of the wire is assured by taking out the wire from the front end of a current contact tube.

An example of the method for controlling a nominal wire diameter ratio, i.e. the ratio of the thickest diameter portion to the shortest diameter portion of the wire diameter which is measured in the circumferential direction is disclosed in Japanese Patent Laid-open No. 5-185232, in which the directional change in the thickest diameter portion of the wire, i.e. a distortion angle, is controlled within 600 angle or less, thereby preventing the occurrence of bead meandering upon taking out the wire from a pail pack.

However, since a welding wire is manufactured by forming a metal sheath into a ‘U’ shape, packing the inside of the metal sheath with a flux and forming it into a metal pipe shape, a seam section is necessarily required to be formed on the surface of the wire in a length direction of the wire. The methods discussed above are limited in the prevention of the occurrence of bead meandering.

The flux cored wire comprising a metal pipe in the direction of the cross section and a flux composition filled in the metal pipe of U-shape is larger than solid wire in the deviation of tensile strength generated by a pipe forming and than a following wire drawing process due to the seam section.

The flux packed into the welding wire also affects the tensile strength of the flux cored wire, making the deviation larger.

As the deviation in the tensile strength of the flux cored wire is large, the rectilinear property of the wire at the front end of a current contact tube in welding is deteriorated, which causes the occurrence of bead meandering in the welded portions.

Thus, there is a need to lower the deviation in the tensile strength of a flux cored wire in order to improve the rectilinear property in welding and prevent the occurrence of bead meandering.

### SUMMARY OF THE INVENTION

Therefore, the present invention has been made in view of the above problems, and it is an object of the present invention to provide a flux cored wire for gas shielded arc welding having improved rectilinear property without occurrence of bead meandering even in the case that welding is performed at high speed or a conduit cable for welding is highly curved.

In order to accomplish the above objects of the present invention, there is provided a flux cored wire for gas shielded arc welding manufactured by forming a metal sheath, packing the inside of the metal sheath with a flux, followed by forming into a metal pipe shape and wire drawing wherein the range ratio (R_{rcts}/R_{ucts}) of the flux cored wire satisfies Relationship (1) below:
1.4≦(R_{rcts}/R_{ucts})≦4.0 (1)
wherein R_{rcts} represents the range of tensile strength of real cross section (that is, real tensile strength range in a state where a flux is packed)
R_{ucts} represents the range of tensile strength of unpacked cross section (that is, real tensile strength range in a state where a flux is unpacked).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a scanning electron microscope (SEM) image showing the cross section of a welding wire where a flux is unpacked;

FIG. 2 is a scanning electron microscope (SEM) image showing the cross section of a welding wire where a flux is packed;

FIGS. 3a, 4a, 5a and 6a are microscope (electron or optical) images showing the cross section of test product Nos. 1, 2, 3 and 4, respectively;

FIGS. 3b, 4b, 5b and 6b are images obtained after treating the images of FIGS. 3a, 4a, 5a and 6a using an image analyzing system, respectively;

FIG. 7 is a diagram schematically showing an apparatus for evaluating the rectilinear property of a flux cored wire for gas shielded arc welding according to the present invention; and

FIG. 8 is a graph showing the change in the rectilinear property according to the ratio R_{rcts}/R_{ucts}.

### DESCRIPTION OF THE PREFERRED EMBODIMENTS

Hereinafter, a flux cored wire for gas shielded arc welding according to the present invention will be explained with reference to the accompanying drawings.

Improvement in the rectilinear property of a flux cored wire can be attained by minimizing the difference between the maximum and minimum values, i.e. apparent tensile strength range, in the nominal tensile strength of the flux cored wire. However, satisfactory results in the rectilinear property of the flux cored wire are not attained to an intended degree by said method.

Since a cavity is formed inside the cross section of a flux cored wire in a metal pipe shape where a flux is packed, the tensile strength of the flux cored wire is different from that of a solid wire in which the cross section is integrally uniform.

The nominal tensile strength can be applied to the solid wire, but has a difficulty in the application to the flux cored wire. Thus, the present inventors found through many experiments that when the real tensile strength range of a flux cored wire is appropriately controlled, the rectilinear property of the flux cored wire can be improved and the occurrence of bead meandering in welding can be prevented.

The nominal tensile strength refers to the ratio of a maximum load to a nominal cross-sectional area of a wire, whereas the term ‘real tensile strength’ used herein refers to the ratio of a maximum load to a real cross-sectional area of a wire. That is, the real tensile strength is defined by the following expression:
Real tensile strength=maximum load/real cross-sectional area

The stable maintenance of the real tensile strength range of a wire at a low level improves the rectilinear property of the wire at the front end of a current contact tube in welding and prevents the occurrence of bead meandering.

For this purpose, the present inventors measured the real tensile strength of a welding wire varied by a packed flux is packed and examined the real tensile strength range.

First, a metal pipe where a flux was unpacked and a flux cored wire where a flux was packed were subjected to wire drawing. At this time, the real tensile strength obtained at the metal pipe portions was measured and the influence of the packed flux on the real tensile strength was examined.

After a welding wire was manufactured in a metal pipe shape without packing a flux therein in order to exclude the influence of the flux, the real tensile strength of the welding wire was measured. Thereafter, the tensile strength of 50 consecutive wire specimens was measured, and the maximum and minimum values were discarded. This procedure was repeated five times, and the obtained values were averaged. As a result, the average value was proved to be 2.0. The real tensile strength range in a state where a metal pipe is unpacked with a flux is referred to as “R_{ucts} (Range of tensile strength of unpacked cross section)”.

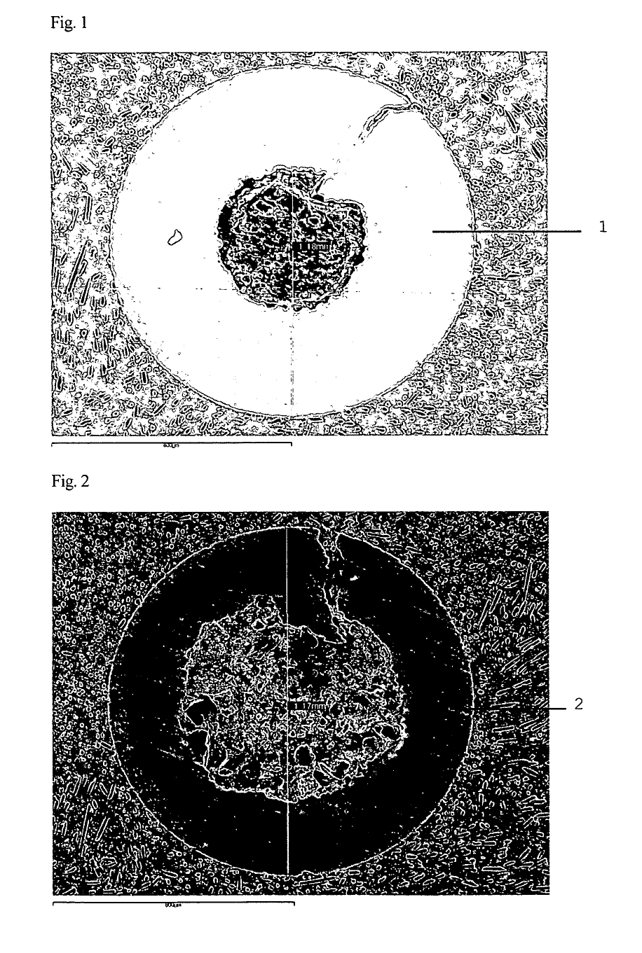

The cross section of the welding wire where a flux was unpacked was photographed using a scanning electron microscope. The photograph is shown in FIG. 1. On the other hand, the cross section of a welding wire where a flux was packed was photographed using a scanning electron microscope. The photograph is shown in FIG. 2. Wherein, a real cross-sectional area 1 and 2 in FIGS. 1 and 2 represents the only metal pipe except a packed flux in the cross-sectional area of the flux cored wire.

Comparing FIG. 1 with FIG. 2, since the flux packed in the inside of the wire pressurizes the inner wall of a metal pipe, which is a sheath of the welding wire packed with the flux, during wire drawing, the thickness of the metal pipe becomes thin, and at the same time, the inner wall of the metal pipe is irregularly rugged.

As can be seen from FIGS. 1 and 2, the packed flux largely affects the cross-sectional area of the welding wire, i.e. real cross-sectional area, during wire drawing. Since the change in the real cross-sectional area also affects the deviation of the real tensile strength, a flux cored wire for gas shielded arc welding having a desired quality can be manufactured by appropriately controlling the real tensile strength based on the influence of the flux on the real tensile strength.

R_{rcts} (Range of tensile strength of real cross section) was divided by R_{ucts} (Range of tensile strength of unpacked cross section) to take into consideration the influence of the flux on the real tensile strength.

Accordingly, a flux cored wire for gas shielded arc welding having improved rectilinear property without the occurrence of bead meandering could be manufactured by appropriately controlling the ratio R_{rcts}/R_{ucts} within the range defined by Relationship (1):
1.4≦(R_{rcts}/R_{ucts})≦4.0 (1)
wherein R_{rcts} represents the ratio of maximum load to real cross-sectional area in a state where a flux is packed, and R_{ucts} is 2.0.

The R_{rcts} and R_{ucts} were obtained in accordance with the following procedure.

First, a flux cored wire for welding having a seam section in the longitudinal direction was cut in a plane perpendicular to the lengthwise direction of the wire to produce test products.

The cut cross section of the test products was mounted, and then grinded and polished using a sand paper. The sand paper used for the grind was selected from #200 to #1500 sand papers. The cross-sectional images of the test products in which the cross section was grinded and polished were obtained using an optical microscope or scanning electron microscope.

These images were treated using an image analyzing system to obtain real cross-sectional areas of the test products. Specifically, the real cross-sectional areas magnified the cross-sectional images of the test products to obtain the cross-sectional areas were obtained by dividing the cross-sectional areas by the magnification of the electron microscope used, or using a calibration bar attached to the images.

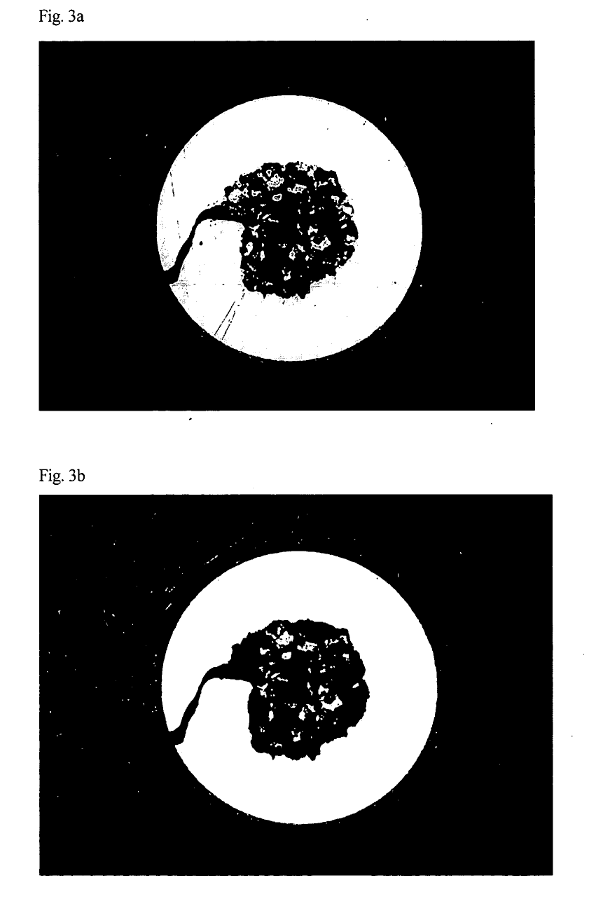

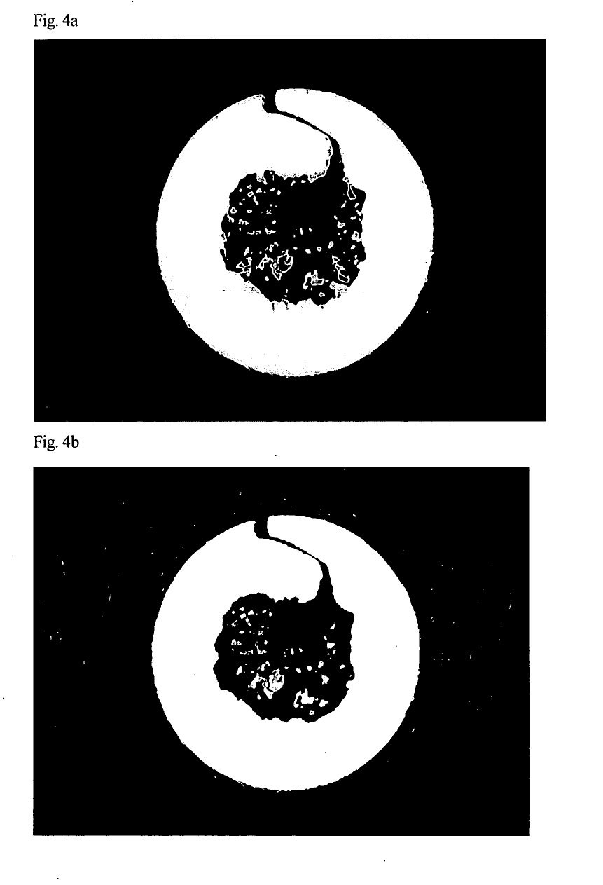

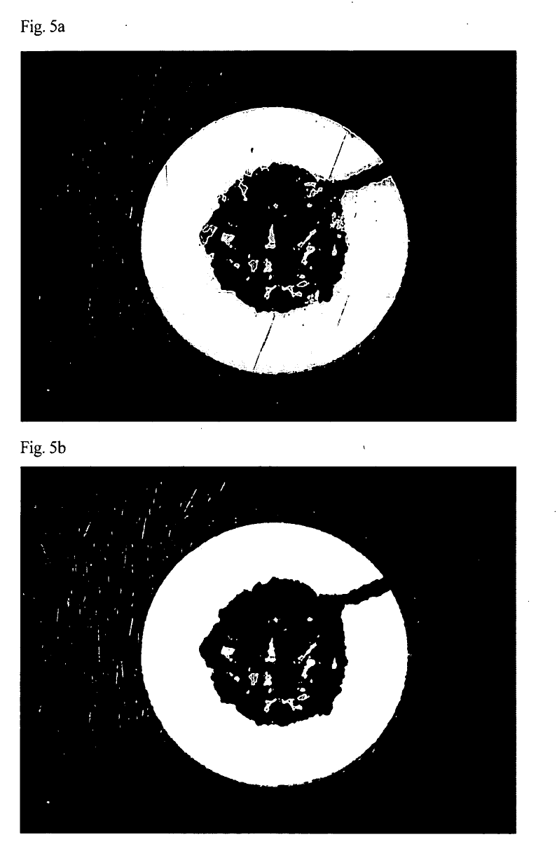

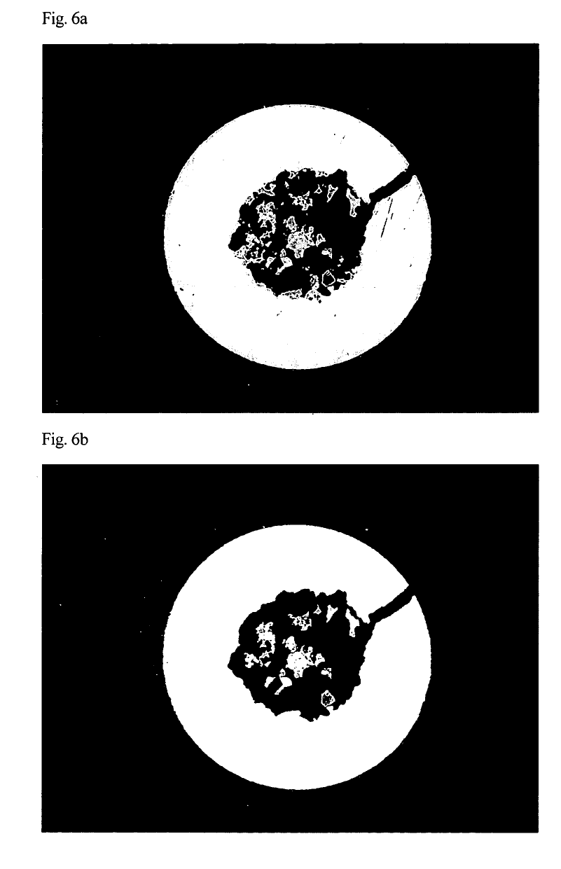

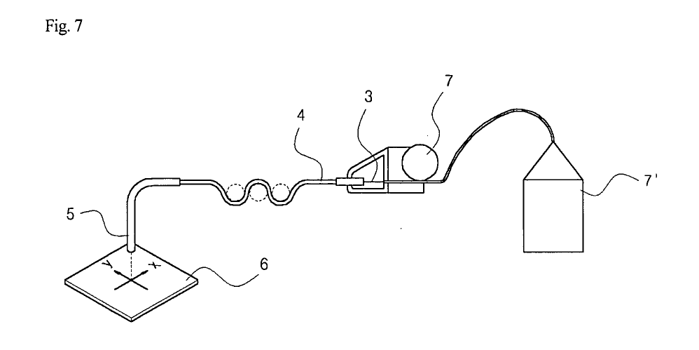

FIGS. 3a, 4a, 5a and 6a are microscope images showing the cross section of test product Nos. 1, 2, 3 and 4, respectively; and FIGS. 3b, 4b, 5b and 6b are images obtained after treating the images of FIGS. 3a, 4a, 5a and 6a using an image analyzing system, respectively. The image analyzing system used to obtain the real cross-sectional area in the present invention was an Image-pro plus 4.0 manufactured by Media cybernetics. Using the image analyzing system, the cross-sectional images of the metal pipes and fluxes were clearly separated from each other. The real cross-sectional area of the test products was obtained from the cross-sectional area of the metal pipes, which were separated from the fluxes and other impurities. The results are shown in Table 1 below.

TABLE 1
Real cross-sectional area of test product Nos. 1˜4 (mm²)

| | Test product | Test product | Test product | Test product |
|---|---|---|---|---|
| No. | No. 1 | No. 2 | No. 3 | No. 4 |
| 1 | 0.7855 | 0.7792 | 0.7762 | 0.8034 |
| 2 | 0.7967 | 0.7955 | 0.7710 | 0.7855 |
| 3 | 0.7992 | 0.8301 | 0.7427 | 0.8127 |
| 4 | 0.8315 | 0.8117 | 0.7579 | 0.8274 |
| 5 | 0.8017 | 0.7986 | 0.7590 | 0.7953 |
| 6 | | 0.7677 | 0.7426 | |
| Average | 0.8029 | 0.7971 | 0.7582 | 0.8048 |

The real cross-sectional area of the welding wire where a flux was unpacked as shown in FIG. 1 was obtained in the same manner as the above procedure.

The real tensile strength range (R) shown in Relationship (1) was obtained by measuring the tensile strength of specimens of 50-consecutive cutting wire wherein the maximum and minimum values were discarded respectively.

Hereinafter, an apparatus for evaluating the rectilinear property is explained with reference to FIG. 7. A flux cored wire 3 for gas shielded arc welding wound around a spool 7 or pail pack 7′ was passed through a 5 m long conduit cable 4 and taken out from the front end of a current contact tube 5. The proceeding direction of the front ending portion of the wire 3 was measured.

The proceeding direction of the front ending portion of the wire 3 was measured in accordance with the following procedure. First, a coordinate plane 6 was spaced apart from the current contact tube 5 of a torch at an interval of 150 mm. The contact point between the first wire 3 taken out from the front end of the current contact tube 5 and the coordinate plane 6 was adopted as an origin. While the wire 3 subsequently taken out from the current contact tube 5 was cut at an interval of 150 mm, the contact points between the wire 3 and the coordinate plane 6 were recorded.

At this time, a conduit cable 4 was formed in a ‘W’ shape. A curved portion of the conduit cable 4 had a diameter of 300 mm, which is a size commonly used for welding process.

For comparison with conventional wires, the procedure was repeated 300 times per each sample.

After the contact points between the flux cored wire 3 for gas shielded arc welding taken out from the current contact tube 5 and the coordinate plane 6 were recorded, the recorded values were statistically processed to obtain a variance thereof.

When the coordinates of each contact point are (X₁, Y₁), (X₂, Y₂), (X₃, Y₃), . . . , (X₃₀₀, Y₃₀₀), the rectilinear property (T) of the welding wire is defined by the following equation:
T=[{(X₁−Xₐ)²+(X₂−Xₐ)²+ . . . +(X₃₀₀−Xₐ)²}/300]+[{Y₁−Yₐ}²+(Y₂−Yₐ)²+ . . . +(Y₃₀₀−Yₐ)²]/300]
(wherein, Xₐ and Yₐ are average values of X and Y values, respectively.)

In order to determine the occurrence of bead meandering of the flux cored wire for gas shielded arc welding, a 5 m long wire was subjected to a bead-on-plate welding in a downward position. The occurrence of bead meandering was judged by a sensory test, based on the following criteria:
O: Many meandering beads were observed.
Δ: Some meandering beads were observed.
X: No meandering bead was observed.

The welding conditions are shown in Table 2 below.

TABLE 2
Welding conditions

| Item | Condition |
|---|---|
| Welding current (A) | 320 |
| Welding voltage (V) | 36 |
| Shield gas | CO₂ 100%, 20 l/min. |
| Welding speed (CPM) | 50 |
| Length of bead | Bead on Plate, 5 m long straight line |
| Conditions of Conduit cable | 5 m, W shape, |
| | diameter of curved diameter: 300 mm |

As can be seen from Table 3 below, wires of comparative examples manufactured without control of the wire drawing process, wire drawing speed and Rₜₛ (Range of tensile strength of raw materials) had a variance in rectilinear property (T) of 20 or more, which was out of the range defined in the present invention. In addition, many meandering beads were observed.

Since the wires of Comparative Examples 1, 4 and 7 had relatively high Rts values, the ratio R_{rcts}/R_{ucts} was out of the range defined in the present invention although the wire drawing speed was appropriately controlled.

A rotating die was used during wire drawing in Comparative Examples 2, 5 and 8. However, the wire drawing speed was so high that the ratio R_{rcts}/R_{ucts} could not be within the range defined in the present invention.

Since the real cross-sectional area of wires of Comparative Examples 8 and 9 became too broad upon wire drawing, wire cutting occurred.

On the contrary, since the ratio R_{rcts}/R_{ucts} in wires of Examples 10 to 18 could be maintained within the range defined in the present invention and a variance of the ratio associated with the rectilinear property (T) could be maintained to 20 or less, the occurrence of bead meandering was prevented.

If the ratio R_{rcts}/R_{ucts} exceeded 4.0, the variance was more than 20 and thus bead meandering occurred. On the other hand, control in the deviation is required to lower the ratio R_{rcts}/R_{ucts} to less than 1.4. However, since the deviation control is limited due to the packed flux, the lower limit of the ratio R_{rcts}/R_{ucts} in the present invention is adjusted to 1.4.

TABLE 3
Change in rectilinear property (T) and the occurrence of bead meandering according to ratio R_{rcts}/R_{ucts} of flux cored wire

| | | Manufacturing conditions | | | | | | | | |
|---|---|---|---|---|---|---|---|---|---|---|
| | | | Wire | | | | | | | |
| | | | drawing | | | | | | Occurrence | |
| Kinds of | | | speed | Rₜₛ of raw | | | R_{rcts}/ | Rectilinear | of bead | |
| data | | Wire drawing | (m/min) | materials | R_{rcts} | R_{ucts} | R_{ucts} | property (T) | meandering | Remark |
| Comp. | 1 | PCD, unbaked type | 500˜1000 | 0.4 | 8.1 | 2 | 4.1 | 25 | Δ | |
| Examples | 2 | PCD + Rotating die, | >1500 | 0.3 | 8.4 | 2 | 4.2 | 27 | Δ | |
| | | unbaked type | | | | | | | | |
| | 3 | CRD + PCD, unbaked type | >1500 | 0.3 | 8.5 | 2 | 4.3 | 27 | Δ | |
| | 4 | PCD, baked type | 500˜1000 | 0.5 | 8.8 | 2 | 4.4 | 30 | Δ | |
| | 5 | PCD + Rotating die, | >1500 | 0.3 | 9.2 | 2 | 4.6 | 36 | Δ | |
| | | baked type | | | | | | | | |
| | 6 | CRD + PCD, baked type | >1500 | 0.3 | 9.5 | 2 | 4.8 | 40 | Δ | |
| | 7 | PCD, baked type | 500˜1000 | 0.6 | 9 | 2 | 4.5 | 30 | ◯ | |
| | | followed by skin pass | | | | | | | | |
| | 8 | PCD + Rotating die, | >1500 | 0.3 | 10.5 | 2 | 5.3 | 52 | ◯ | Wire cutting |
| | | baked type followed by | | | | | | | | occurs upon |
| | | skin pass | | | | | | | | wire drawing |
| | 9 | CRD + PCD, baked type | >1500 | 0.3 | 15 | 2 | 7.5 | 60 | ◯ | Wire cutting |
| | | followed by skin pass | | | | | | | | occurs upon |
| | | | | | | | | | | wire drawing |
| Examples | 10 | CRD, unbaked type | 500˜1000 | 0.2 | 3.4 | 2 | 1.7 | 10 | X | |
| | 11 | PCD + Pressure die, | 1000˜1500 | 0.3 | 3.2 | 2 | 1.6 | 10 | X | |
| | | unbaked type | | | | | | | | |
| | 12 | CRD + PCD, unbaked type | 800˜1000 | 0.3 | 2.8 | 2 | 1.4 | 8 | X | |
| | 13 | CRD, baked type | 500˜1000 | 0.2 | 5.4 | 2 | 2.7 | 15 | X | |
| | 14 | PCD + Pressure die, | 1000˜1500 | 0.3 | 4.8 | 2 | 2.4 | 15 | X | |
| | | baked type | | | | | | | | |
| | 15 | CRD + PCD, baked type | 800˜1000 | 0.3 | 6 | 2 | 3 | 16 | X | |
| | 16 | CRD, baked type | 500˜1000 | 0.2 | 8 | 2 | 4 | 20 | X | |
| | | followed by skin pass | | | | | | | | |
| | 17 | PCD + Pressure die, | 1000˜1500 | 0.3 | 7.4 | 2 | 3.7 | 18 | X | |
| | | baked type followed by | | | | | | | | |
| | | skin pass | | | | | | | | |
| | 18 | CRD + PCD, baked type | 800˜1000 | 0.3 | 6.8 | 2 | 3.4 | 18 | X | |
| | | followed by skin pass | | | | | | | | |

Note:
CRD: Cassette roller die,
PCD: Polycrystalline diamond die,
Rₜₛ of raw materials: Range of tensile strength of raw materials,
R_{rcts}: Range of tensile strength of real cross section, and
R_{ucts}: Range of tensile strength of unpacked cross section.

In some examples shown in Table 3, welding wires were passed through a baking means such as a hot air furnace or baking furnace at suitable temperature in the range of 200 to 600° C. after wire drawing (baked type) to remove lubricants remaining on the surface of the welding wires. Solid wires were subjected to wet degreasing in a chemical degreasing solution to remove lubricants remaining on the surface of the wires. However, since the flux cored wire for gas shielded arc welding according to the present invention comprises a seam section in the longitudinal direction formed along the length of wire on the outer surface and a flux packed therein, the degreasing solution permeates the wire through the seam section and damages the characteristics of the flux cored wire. Accordingly, lubricants remaining on the outer surface of the flux cored wire were removed in a hot air furnace or baking furnace at suitable temperature in the range of 200 to 600° C. In case of having low reduction area rate in wire drawing it is expressed as “skin pass”.

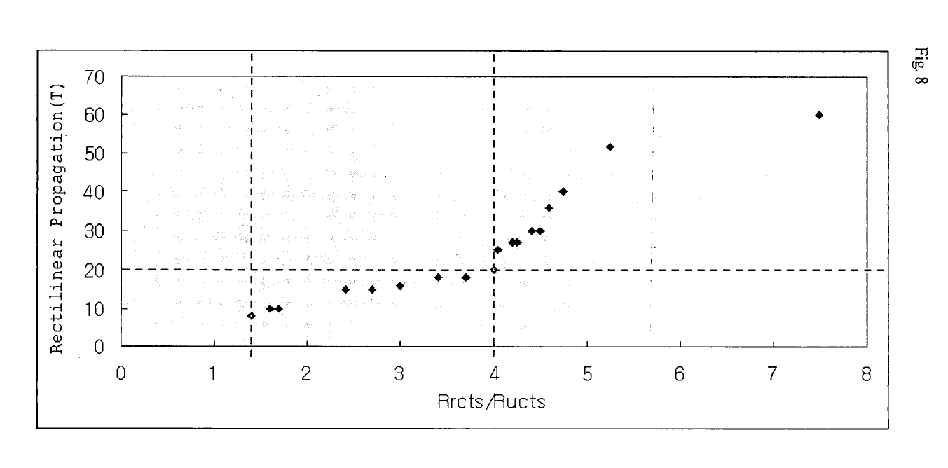

As can be seen from Table 3, the ratio R_{rcts}/R_{ucts} in the flux cored wires of the examples can be maintained within the range defined in the present invention by controlling the wire drawing process, wire drawing speed and Rₜₛ of raw materials. FIG. 8 is a graph showing the change in the rectilinear propagation according to the ratio R_{rcts}/R_{ucts}.

As apparent from the foregoing, although a joint is formed on the outer surface of the flux cored wire for gas shield arc welding according to the present invention, the flux cored wire has improved rectilinear propagation without the occurrence of bead meandering even in the case that welding is performed at high speed or the wire is highly curved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A flux cored wire for gas shielded arc welding manufactured by forming a metal sheath, packing the inside of the metal sheath with a flux, followed by forming into a metal pipe shape and wire drawing,
wherein the flux cored wire satisfies Relationship (1) below:
1.4≦(R_{rcts}/R_{ucts})≦4.0 (1)
wherein R_{rcts} represents the range of tensile strength of real cross section (real tensile strength range in a state where the flux is packed), and
R_{ucts} represents the range of tensile strength of unpacked cross section (real tensile strength range in a state where the flux is unpacked).
